(19) United States
(12) Patent Application Publication
(10) Pub. No.: US 2017/0158217 A1
(43) Pub. Date: Jun. 8, 2017

(54) Bike Stroller

(71) Applicant: PåHoj AB, Malmö (SE)

(72) Inventor: Lycke VON SCHANTZ, Malmö (SE)

(73) Assignee: PåHoj AB, Malmö (SE)

(21) Appl. No.: 15/321,046

(22) PCT Filed: Jun. 30, 2015
(86) PCT No.: PCT/SE2015/050762

§ 371 Date: Dec. 21, 2016

(30) Foreign Application Priority Data
Jul. 4, 2014 (SE) 1450849-3

(51) Int. Cl. B62B 7/12; B62B 5/00; B62B 9/20; B62B 7/06; B60R 22/10; B62J 1/16; B62B 7/00

(52) U.S. Cl. CPC B62B 7/12; B62J 1/16; B62B 5/0003; B62B 7/006; B62B 7/06; B60R 22/105; B62B 9/20; B62B 2205/14

(57) ABSTRACT

A child carrier assembly is removably mountable to a bicycle and includes a seat, a backrest portion, a footrest portion, two side portions, child seating, support for a child while seated, and a docking assembly for connecting the child carrier assembly to the bicycle. The child carrier assembly functions as a convertible stroller by including a wheel assembly and a handle bar, where the docking assembly includes one part fixed to the bicycle and one part fixed to the child carrier assembly. The connection parts are releaseably mountable to one another, wherein the docking assembly includes a spring loaded mechanism that controls the releasable docking assembly by having one movable part and one fixed part. The docking assembly has a locking function so that an upper docking assembly unit fixed to the carrier assembly is dockable and undockable to a lower docking assembly unit fixed to the bicycle.

### FIELD OF THE INVENTION

The present invention relates to a travelling arrangement for smaller children riding a bicycle or in a push cart.

### BACKGROUND OF THE INVENTION

All around the world parents of smaller children are struggling with how to transport their children safely and effectively when travelling. To help with the transportation, there are many different types of aids available, such as car seats, trolleys and strollers.

Depending the child's age, different travelling aids may be more or less suitable. For infants, laying down in a trolley may be the preferred way of travelling, were as for older children, i.e. nine months and older, other forms of transportations may be more suitable such as a stroller.

If travelling with a vehicle, the safest way of travelling is if the child is seated in a specialized seat for that particular type of vehicle. For the car there are numerous types of different car seats available and for the bicycle and/or moped/motorcycle there are other types of specialized seats and for walking there are yet other types of child carrier arrangements. This on the other hand means that there is a need to have many different kinds of seats and travelling arrangement for the children. Having to bring multiple arrangements whilst travelling along with the hassle of switching around the child is considered a major inconvenient.

To mitigate the problem with having to bring multiple travelling arrangements, various solutions have been tried. As can be seen in patent U.S. Pat. NO. 5,071,146 A, a child or infant stroller is provided which is convertible from an operative stroller to a conventional bicycle infant carrier. This arrangement comprises a seat and a frame member for supporting the seat. The stroller can be placed on the bicycle and there be secured by a belt. This solution is complicated with lots of movable parts that may get stuck when connected to the bicycle. The connection and locking of the chair to the bicycle is also complicated and may compromise safety as the belt function may not adequate secure the stroller to the bicycle.

Another solution may be seen in patent U.S. Pat. No. 5,383,585 A. Here is shown a complex child carrier that is adapted to be removably attached to a bicycle. This patent is having a front wheel assembly attached to an underside of the footrest portion and a rear wheel assembly that is movably fitted to its backrest portion. The rear wheel assembly is being movable between a range of vertically adjusted and locked positions including a stowed position and an operable position. The complex solution of the carrier's wheel structure may compromise safety as the user may not have full focus on the child whilst with their both hands rigging the wheels of the stroller. This solution demands that the child is taken out of the seat when preparing for stroller mode.

Another solution may be seen in patent WO 99/55572. In this solution an infant stroller is placed on the steering wheel of a bicycle. The stroller is provided with a set of front wheels that is rigidly mounted and a set of rear wheels that are fixed to the seat with hingeable legs. This solution doesn't fully allow the user to freely operate and steer the bicycle as the seat will both be hindering steering as well as the eye sight. The operator may also experience problems for fitting once knees whilst pedalling.

Another solution may be seen in patent U.S. Pat. No. 6,612,645 B1. This complex solution comprises a baby seat with several loose items. The seat is equipped with an extendable handle set, two front wheel bracket sets pivotally joined to the front of the seat body. A pair of rear wheel bracket sets pivotally engaged with a wheel pivot body. Via a triangular fixing piece and wing panel, the seat can be fixedly fastened to a rear carrier of a bicycle. The fastening solution in this patent limits how and where the seat may be mounted.

As lots of people are living in places were storage space is an issue, a travelling arrangement that may have a multiple function, and thereby be able to accommodate more than one type of travelling, that is easy to use, that is quick to use and adjust, that is safe to use and that may be fixed to practically any bicycle type would be beneficiary for the user.

### SUMMARY OF THE INVENTION

The present invention is directed to a child carrier assembly adapted to be removably mounted to a bicycle, where the child carrier assembly comprising a seat, a backrest portion, a footrest portion, two side portions, means for seating a child and means for supporting a child while seated, a docking assembly for connecting the child carrier assembly to the bicycle, wherein said child carrier assembly is adapted to function as a convertible stroller by means of comprising a wheel assembly and a handle bar, wherein said docking assembly comprises one part being fixed to said bicycle and one part being fixed to said child carrier assembly, wherein said connection parts being releaseably mountable to one another, wherein said docking assembly comprises a spring loaded mechanism and wherein said spring loaded mechanism controls said releasable docking assembly by means of comprising one movable part and one fixed part, wherein the docking assembly has a locking function so that an upper docking assembly unit fixed to said carrier assembly is dockable and undockable to a lower docking assembly unit fixed to said bicycle, and wherein the upper docking assembly unit comprises two separate unlocking handles.

The child carrier assembly is adapted to function as a convertible stroller by means of comprising a wheel assembly and a handle bar. One advantage with this is that the child carrier assembly may easily be converted and used both as a child carrier connected to a bicycle and a child carrier that may transport the child while pushing the child in a stroller.

The docking assembly comprises two parts, one part being fixed to the bicycle and one part being fixed to the child carrier assembly. The connection parts in the docking assembly are being releaseably mounted to one another. One advantage with this is that the child carrier assembly quickly and easily may be docked and undocked from the bicycle.

The docking assembly comprises a spring loaded mechanism for controlling the docking between the docking assembly fixed to the bicycle and the docking assembly fixed to the child carrier assembly. The spring loaded mechanism controls the releasable docking assembly by means of comprising one movable part and one fixed part. The movable part is constructed so as to move and receive a fixed part from the opposite part of the docking assembly and then keep the fixed part secured tightly.

As mentioned above, the docking assembly comprises a locking function. The locking function is arranged so that an upper docking assembly unit fixed to said carrier assembly is dockable and undockable to a lower docking assembly unit fixed to said bicycle, and wherein the upper docking assembly unit comprises two separate unlocking handles. The two separate unlocking handles implies that a user needs to perform two separate actions to be able to unlock the upper docking assembly unit from the lower docking assembly unit. According to one specific embodiment the two separate unlocking handles are one rear and one front unlocking handle or bar. Furthermore, according to yet another embodiment, the child carrier assembly comprises a unit for controlling that the upper docking assembly unit and hence child carrier assembly is locked to the lower docking assembly unit.

The child carrier assembly above may comprise a wheel assembly attached to it. The assembly may i.e. have at least one leg with a set wheels attached to it. The wheel assembly may be of a rigid type, but may also comprise articulated joints for being foldable.

One advantage with the rigid type is that the carrier assembly may be made tough and extra durable and one advantage with the carrier comprising a wheel assembly with foldable joints is that the carrier may be made more compact.

The child carrier assembly may also comprise a handle bar to control the stroller when pushing it. This handle bar may be of a rigid type for extra sturdiness or it may be made with articulated joints for extra compactness. The handle bar may be made with a single push bar or it may comprise of one or more separate push bars/handles.

The child carrier assembly above may be constructed so as it may collapse widthwise. One advantage with this is that the child carrier assembly may become smaller and easier to store.

The child carrier assembly may also comprise a safety belt function. One advantage with this is that the child may be safely secured both while the carrier assembly is mouthed on the bicycle as well as it is being used as a stroller.

The child carrier assembly above is constructed to be dockable and undockable to the bicycle whilst the carrier is seated by a child or not. One advantage with this is that the parent will have much more control over the child as it is safely in the parent hands at all time.

Another advantage is that much fewer steps are needed from changing from a stroller to a bicycle carrier assembly as the child doesn't have to jump in and out of the seat. This is possible due to the construction of the docking assembly. The parent simply has to lift the child carrier assembly onto the docking assembly fixed to the bicycle. This is done whilst the child is seated in the carrier. The weight of the seat forces the spring loaded mechanism to move and thereby open up a space to receive a rod that is being fixed to the docking assembly that is fixed on the bicycle. Once the rod is all the way clear in the space, the spring retracts and move the mechanism to its original state, thereby closing the space with the rod inside and locking the child carrier assembly to the bicycle. Once the child carrier assembly is fixed to the docking assembly that is fixed to the bicycle, the docked assembly is not allowed to move in any direction.

The docking assembly is equipped with a release mechanism. To release the child carrier assembly, the user forces the spring loaded mechanism to open up and then the child carrier assembly may be lifted up, with the child seated, and placed on the ground on its wheels and is ready to be used as a stroller.

According to one embodiment, the spring loaded movable part comprises two separate sliding units which are independent of each other. This is further described below in relation to the figures.

### BRIEF DESCRIPTION OF THE DRAWINGS

FIG. 1 shows a child carrier assembly, a docking assembly and a bicycle.

FIG. 2 shows the same as in FIG. 1, but with the child carrier assembly being docked to the bicycle.

FIG. 3 shows a close up side view of the docking assembly.

FIG. 4 shows a 3D view of the docking assembly shown in FIG. 3.

FIG. 5 shows a close up side cut through view of the docking assembly in a so called closed position.

FIG. 6 shows the close up side cut through view of the docking assembly in a so called semi-closed position.

FIG. 7 shows the close up side cut through view of the docking assembly in a so called open position.

FIG. 8 shows a front view of the docking assembly as seen in FIG. 3 and a seat.

FIG. 9 shows a possible child carrier assembly model.

FIG. 10 shows the two ways the child carrier assembly is meant to be used. Mounted on a bicycle and as a stroller.

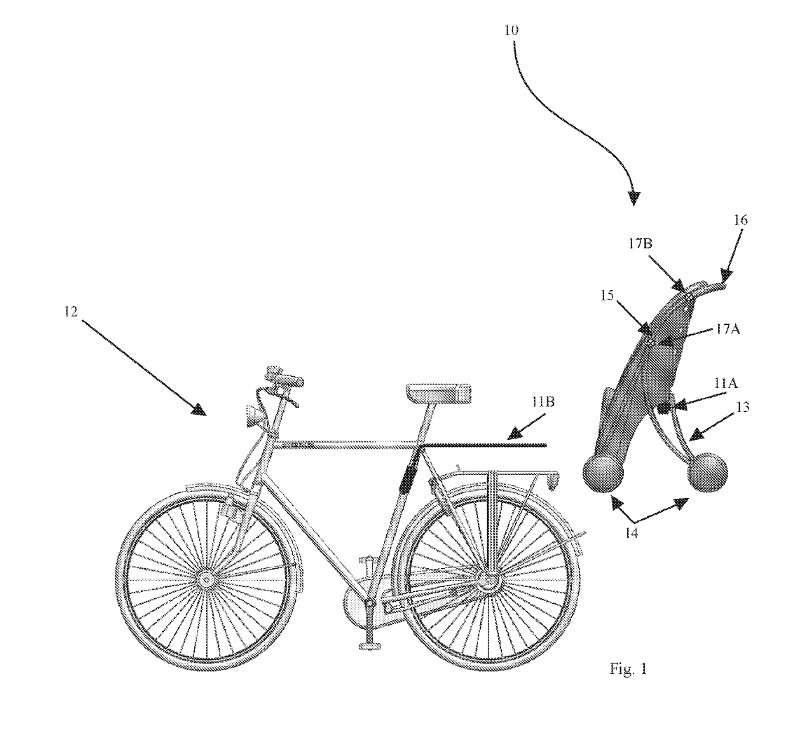

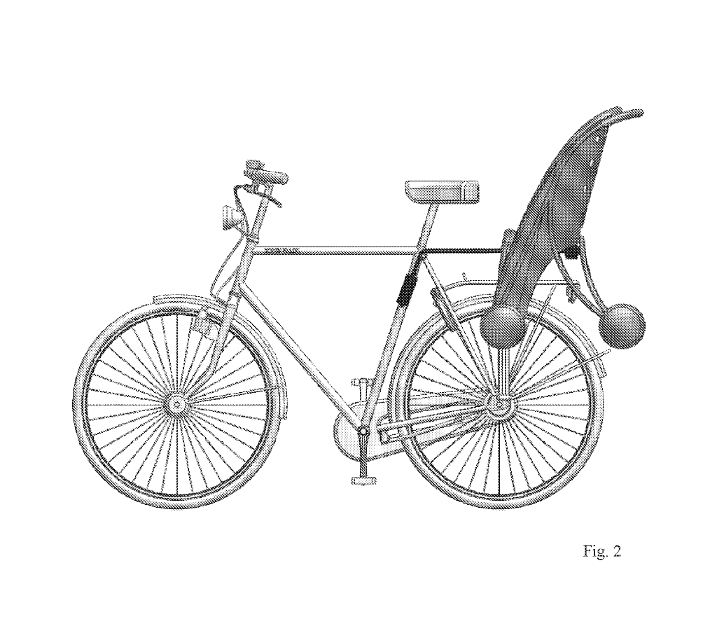

### DETAILED DESCRIPTION

The child carrier assembly 10 may be of different sizes. The carrier assembly 10 comprises of a seat with a backrest portion, a footrest portion, two side portions, means for seating a child and means for supporting the child while seated. In one embodiment the seat 15 is made up from several pieces that are joined together. In one embodiment the plastic in the seat 15 is moulded and in another embodiment the plastic in the seat 15 is formed through vacuum forming or injection moulding. The seat 15 may be made from different materials such as plastic, composite, cloth and metal.

The child carrier assembly 10 also comprises an upper docking assembly unit 11A and lower docking assembly unit 11 B for connecting the assembly 10 to a bicycle 12. Said docking assembly units 11A and 11B are made up of two dockable parts, an upper docking assembly unit (part) 11A and a lower docking assembly unit (part) 11B and in one embodiment the docking assembly units 11A and 11B may be made from a metal or from a toughened plastic.

As seen in the figures, the upper docking assembly part 11A may be connected to the seat underneath the seat 15, whereas the lower docking assembly part 11B may be connected to a bicycle 12.

The lower docking assembly part 11B may be fastened to the frame by the user on his or her bicycle 12 and stays fasted to the bicycle at all time. The lower docking assembly part 11B may in one embodiment be constructed of a clamp 31 for connecting to a bicycle frame and a hoop 43 made from a metal pipe. The hoop 43 being connected in its one end to the clamp and being elongated and curved in an angle away from the connection clamp 31. For extra sturdiness the hoop 43 may have one or more rods 46 placed in between the hoop 43 pipes. At least one metal connection rod 44 is placed in between the hoop 43 pipes.

The connection rod 44 is used for attaching the upper docking assembly 11A to the lower docking assembly 11B. In one embodiment, more than one connection rod 44 may be used and in one embodiment the stabilizing rods 46 may be used as connection rods.

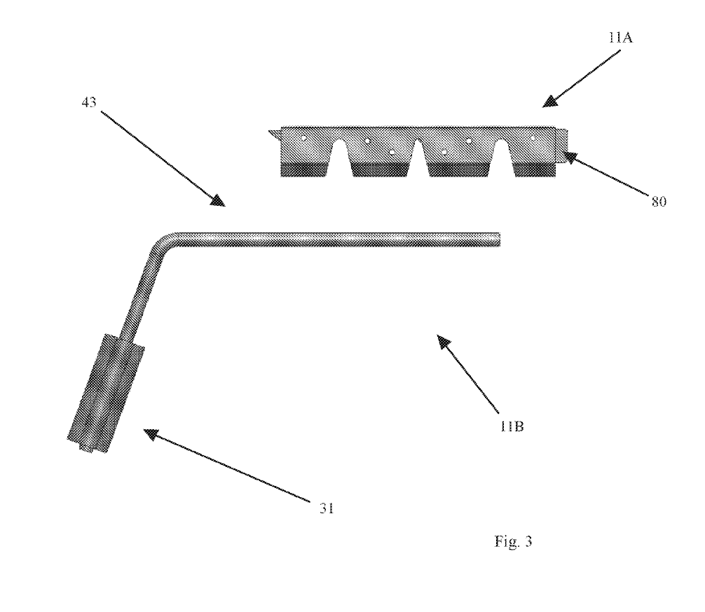

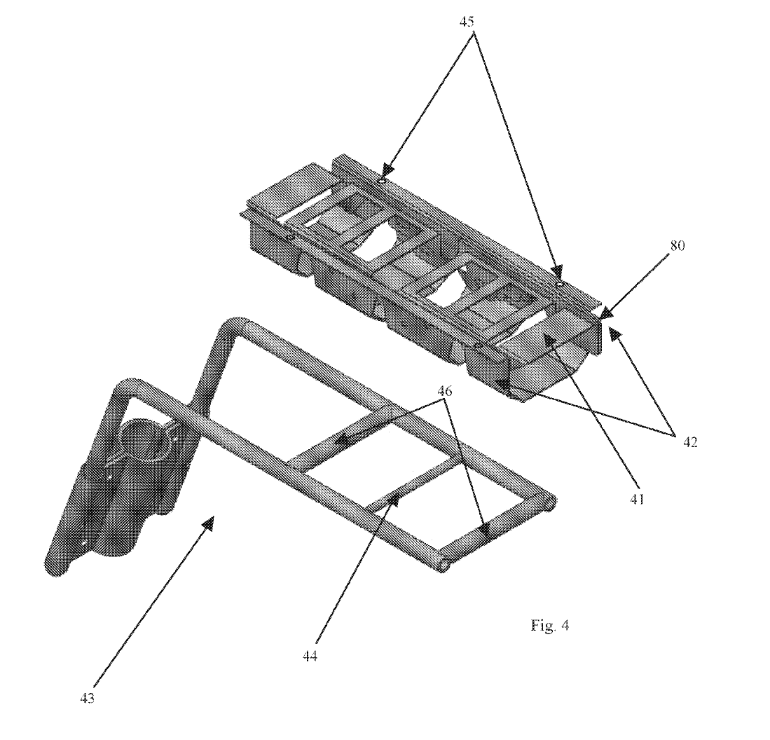

As seen in FIG. 3, the child carrier assembly 10 may also comprise unit (80) for controlling that the upper docking assembly unit (11A) and hence child carrier assembly (10) is locked to the lower docking assembly unit (11B). In this case the unit (80) is positioned on the upper docking assembly unit 11A.

The lower docking assembly part 11B may be purchased or may be delivered lose for the user to fastened. In one embodiment, the upper and lower docking assembly units, 11A and 11B, may be releaseably connected to one another.

The docking assembly units 11A and 11B comprise a spring loaded mechanism for controlling the docking between the lower docking assembly unit 11B and the upper docking assembly unit 11A. The spring loaded mechanism controls the releasable docking assembly by means of comprising one movable part and one fixed part. The movable part may in one embodiment be a flat iron 51 that is connected to the lower docking assembly unit 11B via an arrangement that lets the flat iron 51 move in a predetermined track 52. The flat iron may move in one specified direction and having a set distance that it may move. The flat iron 51, or in two pieces 51a and 51b as discussed below, may have a cavity space 53 and said cavity space 53 may be shaped to create a hook like cavity. The flat iron 51 may also have a slanted part 54.

At least one spring 55 is connected to the movable flat iron 51 and said spring 55 is holding the flat iron 51 in tension. Once the child carrier assembly 10 is being lowered onto the lower part of the docking assembly 11B, guiding flanges may help to guide the hoop 43 in the right position and once the connection rod 44 hits the slanted part 54 of the movable flat iron 51, the flat iron 51 is pushed to move and thereby tensing the spring 55.

Once the connection rod 44 has moved the flat iron 51 a predetermined distance, the connection rod 44 may fit inside the cavity space 53 and the spring 55 retracts the flat iron 51 to its originated state thereby closing the cavity space 53 and locking the connection rod 44 in place. The child carrier assembly 10 will no longer be able to move in any direction.

In one embodiment the flat iron 51 may be locked in the retracted state, hence allow locking the child carrier assembly 10 to the docking assembly units 11A and 11B. In one embodiment the release of the child carrier assembly 10 is carried out by the user pushing a release button or unit 41. Said release button or unit 41 may be connected to the flat iron 51 and the flat iron 51 is thereby being controlled by the user. Since the docking assembly units 11A and 11B allows for simple docking and undocking with only a few necessary steps, this allows that the child is being seated during the entire procedure.

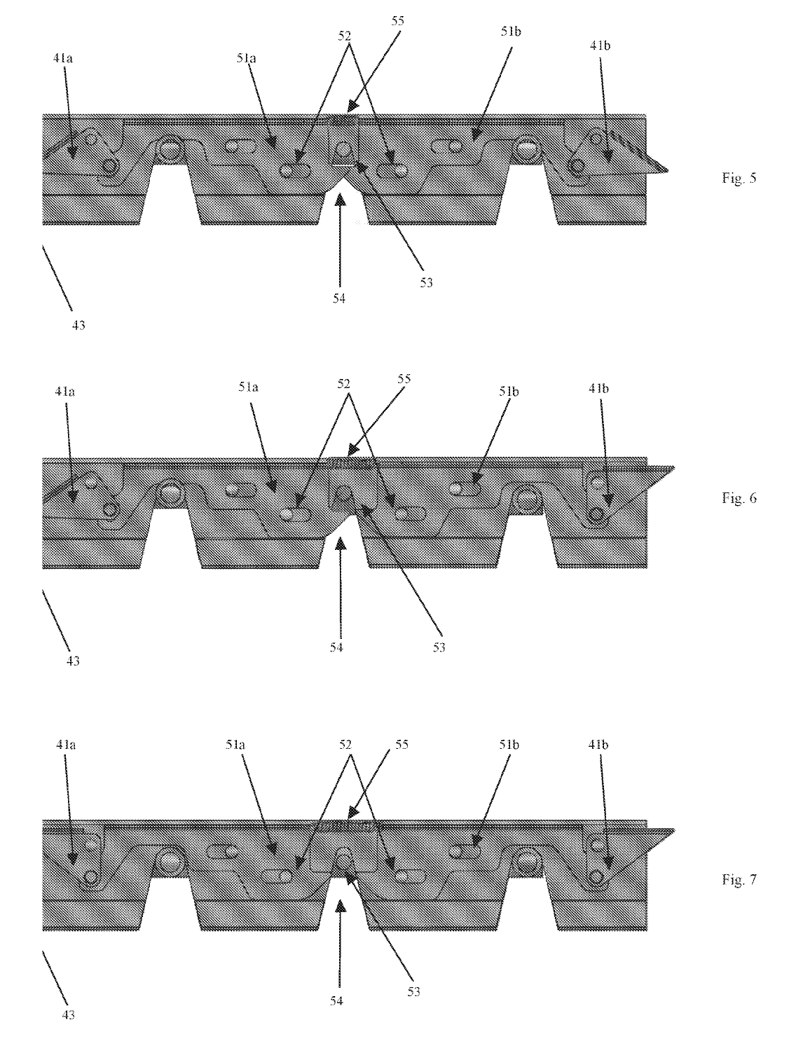

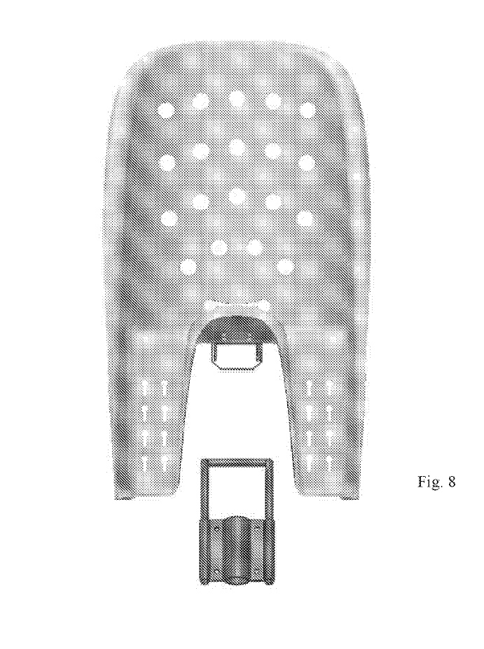

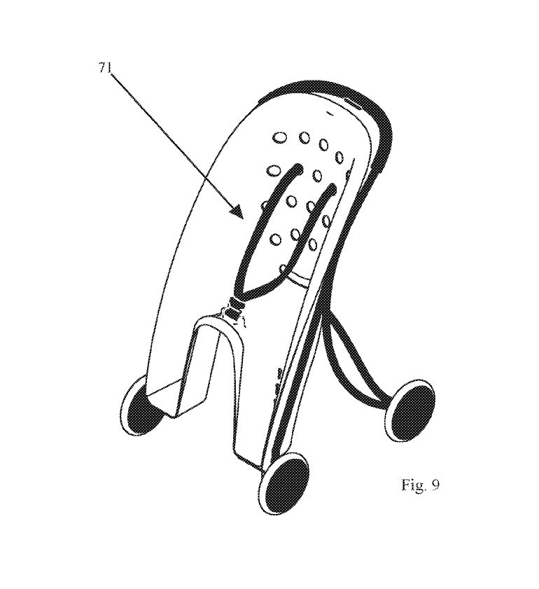

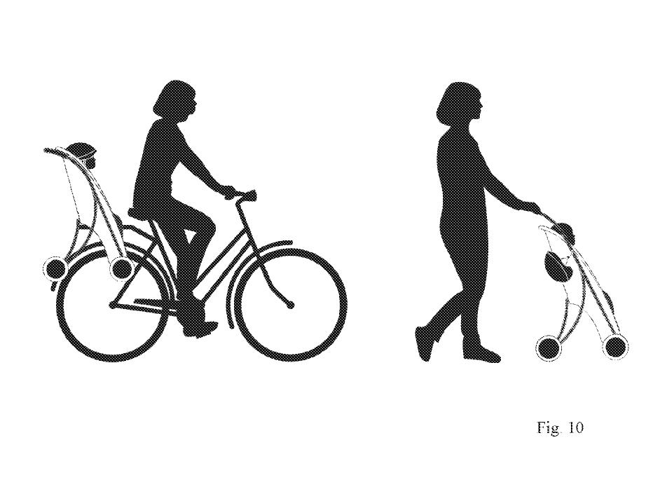

According to one specific embodiment of the present invention, the spring loaded movable part 51 comprises two separate sliding units 51a, 51b which are independent of each other. This is seen in FIGS. 5-7. In FIG. 5 the child carrier assembly 10 is in a locked position, which is seen by the position of units (parts, rods) in the tracks 52 and cavity space 53. As there are two separate sliding units 51a and 51b these are not dependent on each other and as such it is possible to obtain an arrangement where two different actions are needed to unlock the assembly. This is further understood from viewing FIGS. 6 and 7 where it is seen a locked position in FIG. 6 and a semi-locked position in FIG. 7.

As notable in FIGS. 5-7, the upper docking assembly unit 11A comprises two separate unlocking handles 41a and 41b which in turn are connected to respective sliding unit 51a and 51b to enable for the user to lock, open and semi-lock the upper docking assembly unit 11A to the lower docking assembly unit 11B.

The child carrier assembly 10 is adapted to function as a convertible stroller by means of comprising a wheel assembly 13. The wheel assembly 13 may in one embodiment be made from a rigid pipe structure that is being attached to the seat 15. The wheel assembly 13 may comprise a set of four wheels 14, but may also comprise fewer than four and more than four wheels. Said wheels 14, may be connected to the wheel assembly 13 or may be attached directly to the seat 15.

The wheel assembly 13 may in one embodiment comprise one or more lockable articulated joints 17A. These joints give the user the possibility to fold the wheel assembly 13 and thereby minimizing the size of the child carrier assembly 10. This may, in one embodiment, be done both when having the child carrier assembly 10 connected to the bicycle 12 as well as when storing the child carrier assembly 10. The articulated joints 17 A have, in one embodiment, more than one possible setting option which allows for the user to i.e. set the angle of the seat 15.

The child carrier assembly 10 comprises, in one embodiment, a handlebar 16. Said handlebar 16 may be constructed from a rigid pipe structure and it may be of a rigid type or may like the wheel assembly 13 have articulated joints 17 B. In one embodiment the handlebar 16 is made from a single push bar, with space for both hands, connecting one side of the wheel assembly 13 to the other. In one embodiment the handle bar 16 may be folded when the child carrier assembly 10 is docked to the bicycle 12.

In one embodiment the seat 15 and the wheel assembly 13 of the child carrier assembly 10 may be constructed so it will allow the user to collapse the child carrier assembly 10 widthwise. This feature along with the possibility to fold the wheel assembly 13 and fold the handle bar 16 will minimize the storage space needed for the child carrier assembly when not used. It will also allow the user to more easily transport and move the child carrier assembly 10 around when no child is seated.

In one embodiment the handle bar 16 is made from two or more single hand push bars/handles running on each side of the wheel assembly 13. Having separated push bars/handles may be particularly useful when the stroller is of a collapsible type.

In one embodiment the child carrier assembly 10 may comprise a safety belt 71. Said safety belt 71 is constructed to keep the seated child in the seat 15 and prevent the child from falling out. It may be used both when using the child carrier assembly 10 as a stroller and when the child carrier assembly 10 is docked to a bicycle 12.

In one embodiment the child carrier assembly 10 is equipped with at least one handle bar placed i.e. at the front of the seat 15, the back of the seat 15 and/or at the sides of the seat 15. Said handle bar/bars is for the user to hold the child carrier assembly 10 when lifting it up and down front the docking assembly. The handle bar/bars may also be used for the seated child to hold on to while travelling.

1-12. (canceled)

13. A child carrier assembly adapted to be removably mounted to a bicycle, said carrier assembly comprising a seat, a backrest portion, a footrest portion, two side portions, means for seating a child and means for supporting a child while seated, a docking assembly for connecting said child carrier assembly to said bicycle,
wherein said child carrier assembly is adapted to function as a convertible stroller by means of comprising a wheel assembly and a handle bar,
wherein said docking assembly comprises one part being fixed to said bicycle and one part being fixed to said child carrier assembly,
wherein said connection parts being releaseably mountable to one another, wherein said docking assembly comprises a spring loaded mechanism and wherein said spring loaded mechanism controls said releasable docking assembly by means of comprising one movable part and one fixed part,
wherein the docking assembly has a locking function so that an upper docking assembly unit fixed to said carrier assembly is dockable and undockable to a lower docking assembly unit fixed to said bicycle.

14. The child carrier assembly according to claim 13, wherein the upper docking assembly unit comprises two separate unlocking handles.

15. The child carrier assembly according to claim 13, wherein the child carrier assembly comprises a unit for controlling that the upper docking assembly unit and hence child carrier assembly is locked to the lower docking assembly unit.

16. The child carrier assembly according to claim 13, wherein said locking function is part of said docking assembly and said locking function is locked and opened without having to use any external tool.

17. The child carrier assembly according to claim 13, wherein said wheel assembly of said stroller has at least one leg with a wheel attached.

18. The child carrier assembly according to claim 13, wherein said wheel assembly of said stroller has at least one articulated joint.

19. The child carrier assembly according to claim 13, wherein said handle bar of said stroller has at least one articulated joint.

20. The child carrier assembly according to claim 13, wherein said handle bar comprises one or more separate handles.

21. The child carrier assembly according to claim 13, wherein said assembly comprises a safety belt function.

22. The child carrier assembly according to claim 13, wherein said stroller and said carrier assembly is collapsible.

23. The child carrier assembly according to claim 13, wherein said docking assembly fixed to said carrier assembly is dockable and undockable to the docking assembly fixed to said bicycle whilst said carrier is seated by a child, by means of docking said docking assembly fixed to said carrier assembly in a vertical motion onto said docking assembly fixed to said bicycle, thereby forcing said spring loaded moveable part to move and lock said docking assembly fixed to said carrier to said docking assembly fixed to said bicycle.

24. The child carrier assembly according to claim 23, wherein said docking assembly prevents movement of said carrier assembly vertically, horizontally or a combination thereof whilst said carrier assembly is docked in said docking assembly.

25. The child carrier assembly according to claim 13, wherein the spring loaded movable part comprises two separate sliding units which are independent of each other.
